(19) United States
(12) Patent Application Publication
(10) Pub. No.: US 2026/0233829 A1
(43) Pub. Date: Aug. 13, 2026

(54) Wake Filling for Propeller Noise Reduction

(71) Applicant: Textron Aviation Inc., Wichita, KS (US)

(72) Inventors: Steve KLAUSMEYER, Wichita, KS (US); Kelly LAFLIN, Wichita, KS (US); Scott SANBORN, Wichita, KS (US)

(21) Appl. No.: 19/049,748

(22) Filed: Feb. 10, 2025

(51) Int. Cl. B64C 21/04

(52) U.S. Cl. CPC B64C 21/04; B64C 2230/14

(57) ABSTRACT

A pusher propeller aircraft and method of compensating for a low velocity air flow region behind a trailing edge of a wing of the pusher propeller aircraft. The pusher propeller aircraft may include the wing having output openings at or proximate to the trailing edge, as well as a propeller and a blowing system. The propeller has a plurality of blades rotatably fixed to and located aftward of the wing, and the blowing system is at least partially located within the wing and provides a free air jet through the output openings in a direction aftward toward the propeller. The method includes rotating the propeller and releasing the free air jet through the output openings, thus building the air flow velocity back up in the low velocity air flow region to provide a more uniform air flow velocity profile through which the blades rotate.

### BACKGROUND OF THE INVENTION

In aviation, a tractor propeller aircraft is a propeller-driven fixed-wing aircraft with its engine mounted with the propeller or propellers in front, so that the aircraft is "pulled" through the air. On the other hand, a pusher propeller aircraft places the propeller or propellers behind and "pushes" the aircraft forward.

A pusher propeller aircraft has a number of benefits in comparison to a tractor propeller aircraft. Specifically, high velocity “prop wash” (the force or wind that is generated behind a propeller) of a tractor propeller immediately encounters the fuselage or wing, introducing more drag to the aircraft in comparison with the pusher propeller. Furthermore, the pusher-propeller configurations allow positioning the propeller plane aft of the aircraft center of gravity, eliminating the de-stabilizing effect of the traditional tractor-propeller configuration, yielding more favorable stability changes with power and improving stall characteristics.

However, the pusher propeller aircraft also introduces some disadvantages that cause it to be utilized much less than the traditional tractor propeller aircraft configuration. Specifically, propeller interaction with airframe flow disturbances generates a large amount of noise and reduces performance. This problem is amplified for pusher propeller aircraft where the wake from an upstream wing, fuselage, tail or other aerodynamic surface sheds directly into the propeller plane generating intense acoustic pressure pulses as the blades of the propellers periodically slice through the wake. Noise is generated as the propeller blades pass through the velocity defect region of the wake. The primary reason pusher propellers are not more prevalent is due to unacceptable noise levels, particularly in the era of ever-tightening Committee on Aviation Environmental Protection (CAEP) requirements. Pusher propeller aircraft generally have a 20-30 dB noise penalty over tractor propeller aircraft.

Thus, there is a need for a pusher propeller aircraft configuration that overcomes the deficiencies of the prior art.

### SUMMARY OF THE INVENTION

Embodiments of the current invention address one or more of the above-mentioned problems and provide a distinct advance in the art of pusher propeller aircraft. Specifically, the aircraft pusher propeller configuration described herein eliminates or reduces the velocity defect interacting with the propellers, thus also eliminating or reducing the noise traditionally caused by intense acoustic pressure pulses as the blades of the propellers periodically slice through the wake from an upstream wing, fuselage, tail or other aerodynamic surface.

For example, in one embodiment, a pusher propeller aircraft includes an airframe structure, an aircraft engine fixed to the airframe structure, one or more rotatable propellers rotatably fixed to the aircraft engine and located aftward of the airframe structure, and a blowing system providing a free air jet blowing from the airframe structure aftward toward the propellers.

In another embodiment, a pusher propeller aircraft has a wing, a propeller, and a blowing system. The wing has a leading edge, a trailing edge, and one or more output openings at or proximate to the trailing edge. The propeller has a plurality of blades rotatably fixed to and located aftward of the wing. The blowing system is at least partially located within the wing and provides a free air jet through the one or more output openings in a direction aftward toward the propeller.

In yet another embodiment, a method of compensating for a low velocity air flow region generated by a wake formed during flight by a wing of a pusher propeller aircraft aftward of a trailing edge of the wing includes the steps of rotating a propeller and releasing at least one free air jet from the wing. The propeller is attached to the wing and is located aftward of the trailing edge of the wing. The at least one free air jet is released through one or more output openings at or proximate to the trailing edge of the wing. In this embodiment, the one or more output openings cooperatively span a width at least equal to a width of the propeller. The at least one free air jet is directed toward and intersects blades of the propeller.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a schematic plan view of a pusher propeller aircraft constructed in accordance with embodiments of the present disclosure;

FIG. 2 is a prior art schematic plan view of a wing of a pusher propeller aircraft, depicting a velocity defect caused by a wake of the wing;

FIG. 3 is a schematic plan view of the wing of the pusher propeller aircraft of FIG. 1, depicting a blowing system filling in a velocity defect caused by a wake of the wing in accordance with embodiments of the present disclosure;

FIG. 4a is an exemplary chart depicting the impact of the blowing system on the velocity defect when the propeller is a first distance aftward of a trailing edge of the wing;

FIG. 4b is an exemplary chart depicting the impact of the blowing system on the velocity defect when the propeller is a second distance aftward of a trailing edge of the wing;

FIG. 4c is an exemplary chart depicting the impact of the blowing system on the velocity defect when the propeller is a third distance aftward of a trailing edge of the wing;

FIG. 4d is an exemplary chart depicting the impact of the blowing system on the velocity defect when the propeller is a fourth distance aftward of a trailing edge of the wing; and

FIG. 5 is a method for compensating for the velocity defect caused by the wake of the wing in accordance with one embodiment of the present disclosure.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

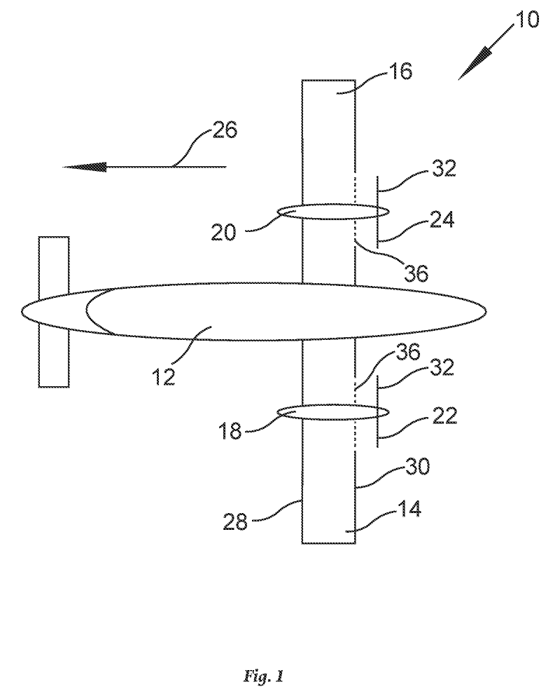

In one or more embodiments described herein, as depicted in FIG. 1, a pusher propeller aircraft 10 comprises a fuselage 12, wings 14,16, engines 18,20, and propellers 22,24, among other components known in the art. A direction of travel is indicated by arrow 26 in FIG. 1, and the propellers 22,24 are located aftward of the wings 14,16 and the engines 18,20. Specifically, the engines 18,20 are fixedly mounted to the wings 14,16 and the propellers 22,24 are rotatably mounted to the engines 18,20 respectively. Thus, by way of the engines 18,20, the propellers 22,24 are rotatably fixed to and located aftward of the wings 14,16. The wings 14,16 may each have a leading edge 28 and a trailing edge 30. The propellers 22,24 may each have a plurality of blades 32 rotatably fixed to (e.g., via the engines 18,20) and located aftward of the wings 14,16. The blades 32 are angled to push air backwards relative to the direction of travel 26.

In use, the engines 18,20 operate to rotate the blades 32 of the propellers 22,24 which in turn push air backwards, generating thrust that propels the pusher propeller aircraft 10 forward. That is, spinning propellers 22,24 create a pressure difference between a front and back of the propellers 22,24, with lower pressure in front causing the air to be pulled in and then accelerated backwards, resulting in forward thrust for the pusher propeller aircraft 10.

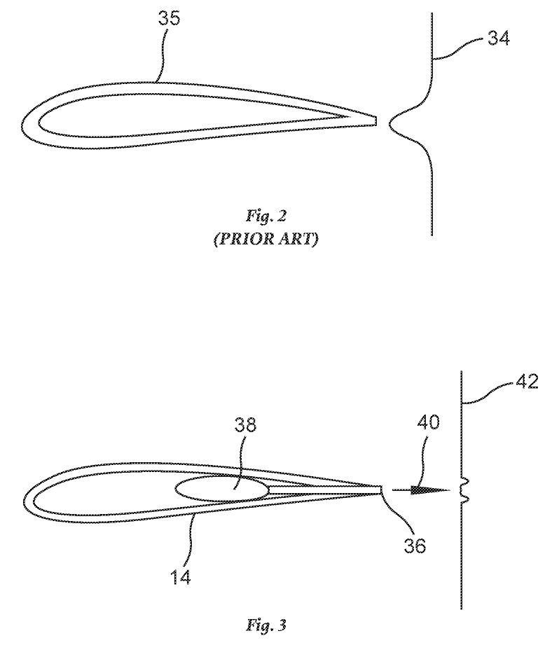

Traditionally, because the propellers 22,24 are located aft of the wings 14,16, an air flow wake of the wings 22,24 directly impact the propellers’ incoming air flow. This can create a “washout” effect where the propeller blades encounter a slightly slower air stream due to the disturbed air coming from the wings’ trailing edge wake. For example, as depicted in FIG. 2, the line labeled 34 is representative of air speed aftward of a wing 35 of a prior art pusher propeller aircraft. As can be seen, in prior art pusher propeller aircraft, a velocity defect (also referred to herein as a low velocity air flow region) forms.. The location of this velocity defect can be influenced by the wing design, angle of attack, and propeller placement. This velocity defect can be disadvantageous, because as propeller blades rotate above or below this velocity defect, they are receiving air at a fairly constant velocity, but then as the propeller blades rotate through the wing wake or velocity defect, noise is generated. Specifically, intense acoustic pressure pulses are generated as the propeller blades periodically slice through the wing wake.

However, the present invention compensates for this phenomenon with the addition of output openings 36 in the wings 14,16 (as depicted in FIG. 1) and a blowing system 38 (as depicted in FIG. 3) at least partially located within the wings 14,16. For example, as depicted in FIG. 3, the blowing is configured to provide a free air jet 40 blowing from the wing 14 aftward (e.g., toward the propellers 22,24), thereby filling in the wing wake or velocity defect. Specifically, as depicted via line 42 in FIG. 3, which is representative of air speed aftward of the wing 14, the wing wake is at least partially filled by the free air jet 40, reducing or eliminating the negative effects described above when the blades 32 slice through the wing wake. Note that while a single free air jet 40 is schematically depicted and described herein, the free air jet 40 may also refer to a plurality of free air jets 40 output via a plurality of output openings (e.g., the output openings 36 in FIG. 1) without departing from the scope of the technology herein.

The output openings 36 are formed through an airframe structure such as the wings 14,16, fluidly coupled with the blowing system 38, and positioned to direct a free air jet 40 generated by the blowing system 38 toward the velocity defect (e.g., the wing wake) and/or one of the propellers 22,24. In some embodiments, the output openings 36 may be located at or proximate to the trailing edges 30 of one or each of the wings 14,16. For example, the output openings 36 may direct the free air jet 40 in a direction opposite of the direction of travel, such as toward the blades 32 of the propellers 22,24 at a location where the wing wake intersects the rotating blades 32. Alternatively, the output openings 36 may be formed into a lower surface or an upper surface of one or both of the wings 14,16, with the output openings 36 angled toward the blades 32 of the propellers 22,24 at a location where the wing wake intersects the rotating blades 32. The output openings 36 may, in one or more embodiments, be only located upstream of the propellers 22,24, such that the free air jet 40 intersects with the blades 32 aftward of the trailing edge 30. This provides improved efficiency in that the free air jet 40 is not being blown into additional regions aftward of the wings 14,16 that are not being intersected by the blades 32.

In some embodiments, the output openings 36 comprise one or more orifices or slots angled toward at least one of the propellers 22,24. Additionally or alternatively, the output openings 36 may comprise nozzles that are angled or angleable toward at least one of the propellers 22,24. For example, the nozzle or nozzles may be configured to have an adjustable angle that can be manually and/or electromechanically re-oriented. Adjusting an angle of the nozzles may improve the filling in of the low velocity air flow region or velocity defect and enhanced mixing of the free air jet with the free stream air flow outward of the low velocity air flow region or velocity defect. In some embodiments, the nozzle may be fluidly coupled with the output openings 36, or the output openings 36 may include the nozzles. Additionally or alternatively, the nozzles may be omitted and the output openings may be shaped and angled or otherwise designed to direct the free air jet 40 in a desired direction to fill in the velocity defect or low velocity air flow region with the free air jet 40 from the blowing system 38.

The blowing system 38 may include a single blowing system or two blowing systems each located in one of the wings 14,16. For example, the blowing system 38 may be at least partially located within a hollow space within the wing 14 depicted in FIG. 3. However, additional blowing systems may be used without departing from the scope of the technology herein. The blowing system may comprise, for example, a blower fan, an engine driven compressor, an electric compressor, and an engine bleed ducted to produce the free air jet 40 blowing outward from the output openings 36. However, any source of forced air or forced gas may be output through the output openings 36 to create the free air jet 40 without departing from the scope of the technology herein.

In some embodiments, the pusher propeller aircraft 10 further comprises a control system (not shown) including at least one processing element or processor and any electronic control systems known in the art. The control system may be configured to intermittently pulse the free air jet 40 output by the blowing system 38 in time with rotation of the propellers 22,24. Additionally or alternatively, the control system may be configured to match the free air jet’s mass flow to flight conditions and power settings of the pusher propeller aircraft 10. Furthermore, in one or more embodiments, the control system may be configured to set the free air jet’s mass flow based on at least one of flight conditions, air speed, angle of attack, propeller rotation speed, and/or sensed acoustic properties. Furthermore, in one or more embodiments the pusher propeller aircraft 10 further comprises one or more sensors communicably coupled with the control system, and the control system is configured to set or adjust the free air jet’s mass flow based on acoustic properties or other flight conditions sensed by the one or more sensors.

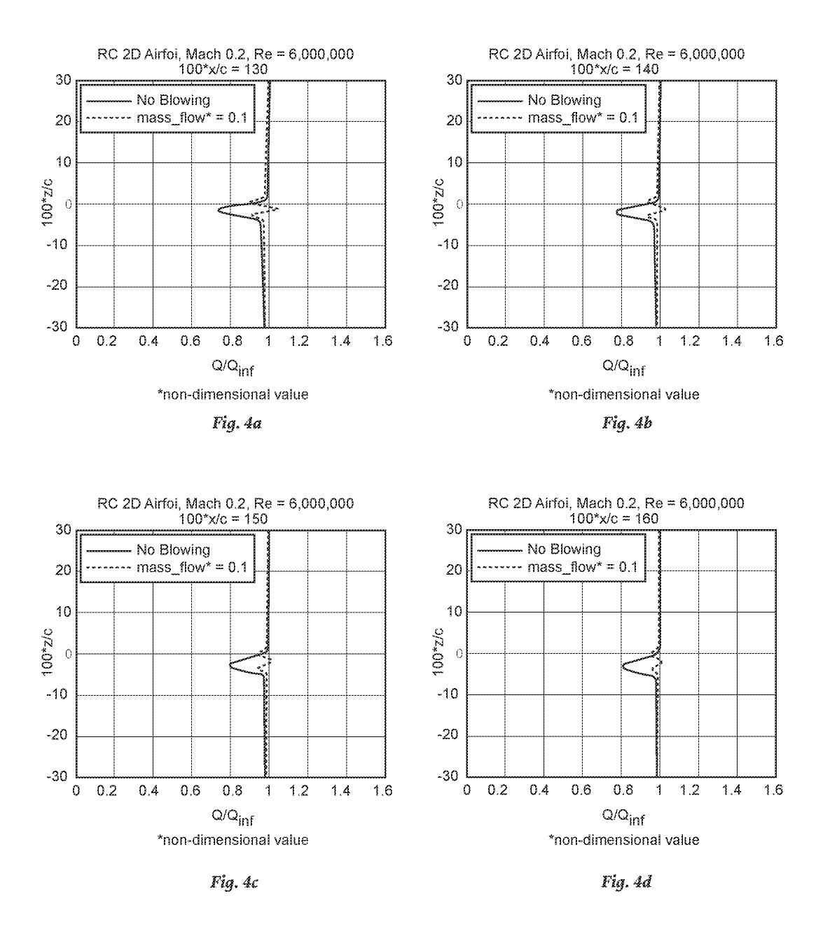

In use, the pusher propeller aircraft 10 uses forced air (e.g., the free air jet 40) from an airframe structure (e.g., one of the wings 14,16) to at least partially fill in a velocity defect caused by a wake of the airframe structure such as the wing wake, thus reducing noise from the propellers spinning into and out of a path of the wake, as described in detail below. To further describe this effect with the propellers at different distances from the trailing edge of the wings, FIGS. 4a-4d provide non-dimensionalized charts depicting the velocity deficit with no blowing of the free air jet 40 and with blowing by an exemplary mass flow rate having a non-dimensional exemplary value. As labeled in these charts, for the horizontal axis, Q is the local dynamic pressure and Qinf is free stream dynamic pressure, so when the charted value is equal to 1 on the horizontal axis, no air flow velocity or energy has been lost. For an efficient system, the goal is for Q/Qinf to be as close to one as possible. For the vertical axis, vertical distance relative to a horizontal axis of the wing based measured as a percentage of the wing’s thickness is numerically represented. For example, a value of 10 would be 10% of the wing’s thickness. FIGS. 4a-4d chart these vertical and horizontal axis values for a propeller that is located aft of the wing’s trailing edge by: 30% of the wing’s chord length for FIG. 4a 40% of the wing’s chord length for FIGS. 4b, 50% of the wing’s chord length for FIG. 4c, and 60% of the wing’s chord length for FIG. 4d. The chord length of the wing is taken from the leading edge to the trailing edge. So combined, FIGS. 4a-4d depict changes in the wing wake as it moves aft from the wing’s trailing edge using the wake filling technology described herein. As can be seen in FIG. 4d, a quieter prop-wing interaction can be achieved the further away the propeller is from the trailing edge of the wing. However, these advantages must be balanced against other design considerations, such as the fact that the propellers still may need to be somewhat close to the trailing edge of the wing for weight considerations.

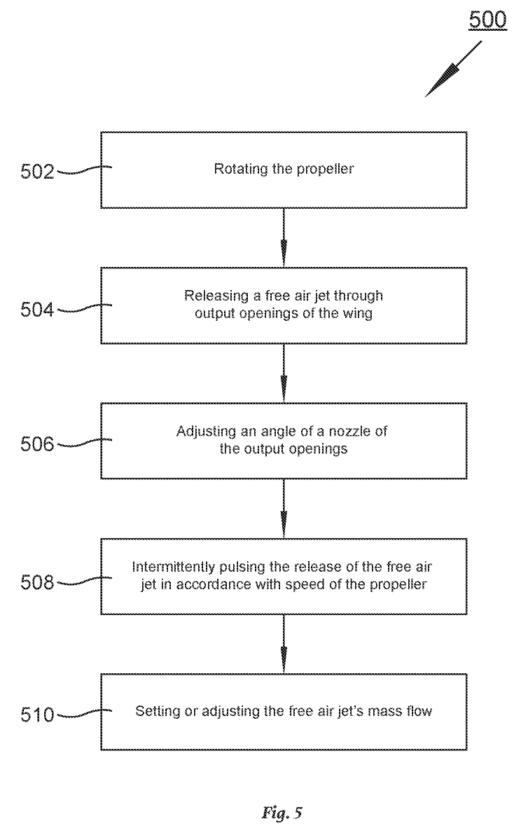

The flow chart of FIG. 5 depicts the steps of an exemplary method 500 for compensating for a low velocity air flow region generated by a wake of air flow formed during flight by an airframe structure or wing in more detail. For example, the method may be used for compensating for the low velocity air flow region or velocity defect aftward of the trailing edge of the wing depicted in FIGS. 1 and 3. In some embodiments, various steps may be omitted, or steps may occur out of the order depicted in FIG. 5 without departing from the scope of the technology as described herein. For example, two blocks shown in succession in FIG. 5 may in fact be executed substantially concurrently, or blocks may sometimes be executed in the reverse order depending upon the functionality involved.

In some embodiments, the method 500 includes the steps of rotating the propeller or propellers 22,24, as depicted in block 502, and releasing at least one free air jet through one or more of the output openings 36 at or proximate to the trailing edge 30 of the wing or wings 14,16, as depicted in block 504. Rotating the propellers 22,24 may include starting the engines 18,20 or other motors or actuators operable for rotating the propellers 22,24, resulting in rotation of the propellers 22,24 to push the aircraft 10 forward. The releasing of the free air jet (e.g., the free air jet 40) may include turning on the blowing system 38 and/or opening a valve or nozzle associated therewith, such that the free air jet 40 fills in or at least partially fills in the velocity defect or low velocity air flow region. The free air jet 40 or free air jets are directed toward and intersect with the blades 32 of at least one of the propellers 22,24. In some embodiments, the output openings 36 of the wings 14,16 may span a width equal to a width of one of the propellers 22,24. Similarly, the free air jet 40, when intersecting the blades 32, may have a width equal to the width of one of the propellers 22,24. The width of the free air jet 40 may refer to a combined width of a plurality of adjacent free air jets output from each of the wings 14,16. However, in some alternative embodiments, the output openings 36 may span a wider width to account for yaw or other spanwise effects that may shift streamlines not directly in front of the propellers 22,24 into the propellers 22,24. For example, a small amount of yaw could result in end portions or tips of the propellers 22,24 to be impacted by the unmodified wake. Thus, the output openings 36 may span a width great enough to account for an amount of yaw anticipated to be experienced by the propellers 22,24. In yet another embodiment, nozzles associated with the blowing system 38 may be laterally angleable to compensate for yaw impacting where the wing wake needs to be filled. For example, sensors configured to sense a sideslip parameter may provide such data to a control system of the aircraft 10, which may then actuate a lateral angle of the nozzles accordingly.

In some embodiments, the method 500 may further comprise adjusting an angle of at least one nozzle, as depicted in block 506, for improved filling in of the low velocity air flow region and enhanced mixing of the free air jet with a free stream air flow outward of the low velocity air flow region. The nozzle may be fluidly coupled with the output openings 36, or the output openings 36 may include nozzles. Additionally or alternatively, the nozzles may be omitted and the output openings 36 may be shaped and angled or otherwise designed to direct the free air jet 40 in a desired direction to fill in the velocity defect or low velocity air flow region with the stream of air forced outward from the blowing system.

Additionally or alternatively, the method 500 may include intermittently pulsing the release of the free air jet 40 in accordance with a speed of one or both of the propellers 22,24, as depicted in block 508. For example, the control system or any control system of the pushed propeller aircraft 10 may instruct the blowing system 38 to turn a blower or a compressor off and on, and/or to open and close a valve or nozzle of the blowing system 38, at predetermined intervals or at intervals that are calculated by the control system based on various flight conditions, propeller rotation speed, or the like. By this pulsing, the free air jet is only used when needed (i.e., at the moment when one of the blades 32 of the propellers 22,24 would slice through the velocity defect). This is more efficient than merely directing the free air jet 40 continuously aftward for the entire time the propellers 22,24 are rotating.

In some embodiments, the method 500 may include a step of setting or adjusting the free air jet’s mass flow (e.g., via the blower system 38), as depicted in block 510, based on one or more of the following: flight conditions, air speed, angle of attack, propeller rotation speed, and sensed acoustic properties. For example, in some embodiments one or more sensors may sense acoustic properties in real time to determine if the velocity defect is being sufficiently compensated for with the free air jet from the blowing system 38 or if the free air jet needs to be adjusted to increase or decrease the flow of air exiting the output openings 36 of the wings 14,16.

Note that while the pusher propeller aircraft 10 is depicted and described as having the propellers attached to and located aftward of the wings, in alternative embodiments the propellers (via the engines) can be attached to and located aftward of other airframe structures in accordance with other pusher propeller aircraft configurations. For example, in some alternative embodiments, the airframe structure is an upstream wing, fuselage, tail, or some other aerodynamic surface. Furthermore, the output openings may be formed through any airframe structure to which an engine and its associated pusher propeller are attached in such a configuration that a blowing system within the airframe outputs a free air jet toward blades of the propeller attached to the airframe (and to the engine associated therewith). For example, in some alternative embodiments, the pusher propeller aircraft may only have a single engine and a single propeller mounted to the fuselage or tail, with the blowing system located within the fuselage or tail and having output openings that are directed in accordance with a wake of the tail and/or the fuselage to similarly fill in the wake or velocity defect via the blowing system using techniques described herein.

### Other Considerations

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor or a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “control system,” “processor”, “processing element”, or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A pusher propeller aircraft, the pusher propeller aircraft comprising:
an airframe structure;
at least one aircraft engine fixed to the airframe structure;
one or more propellers rotatably fixed to the aircraft engine and located aftward of the airframe structure; and
a blowing system configured to provide a free air jet blowing from the airframe structure aftward toward the propellers.

2. The pusher propeller aircraft of claim 1, wherein the airframe structure is at least one of an upstream wing, fuselage, tail or other aerodynamic surface of the pusher propeller aircraft.

3. The pusher propeller aircraft of claim 1, wherein the blowing system is located within the airframe structure, wherein the airframe structure is a wing having a trailing edge and one or more output openings fluidly coupled with the blowing system.

4. The pusher propeller aircraft of claim 3, wherein the one or more output openings are only located upstream of the one or more propellers, such that the free air jet intersects with the one or more propellers.

5. The pusher propeller aircraft of claim 3, wherein the one or more output openings comprise at least one nozzle or at least one orifice or slot angled or angleable toward the one or more propellers.

6. The pusher propeller aircraft of claim 1, further comprising a control system configured to intermittently pulse the free air jet output by the blowing system in time with the one or more propellers.

7. The pusher propeller aircraft of claim 1, wherein the blowing system further comprises at least one of a blower fan, an engine driven compressor, an electric compressor, and an engine bleed ducted to produce the free air jet blowing from the airframe structure aftward toward the propellers.

8. The pusher propeller aircraft of claim 1, further comprising a control system configured to match the free air jet’s mass flow to flight conditions and power settings of the pusher propeller aircraft.

9. The pusher propeller aircraft of claim 1, further comprising a control system configured to set the free air jet’s mass flow based on at least one of air speed, angle of attack, and propeller rotation speed.

10. The pusher propeller aircraft of claim 1, further comprising a control system and one or more sensors communicably coupled with the control system, wherein the control system is configured to set or adjust the free air jet’s mass flow based on acoustic properties sensed by the one or more sensors.

11. A pusher propeller aircraft, the pusher propeller aircraft comprising:
a wing having a leading edge, a trailing edge, and one or more output openings at or proximate to the trailing edge;
a propeller having a plurality of blades rotatably fixed to and located aftward of the wing; and
a blowing system at least partially located within the wing and configured to provide a free air jet through the one or more output openings in a direction aftward toward the propeller.

12. The pusher propeller aircraft of claim 11, wherein the one or more output openings are only located upstream of the propeller, such that the free air jet intersects with the plurality of blades aftward of the trailing edge.

13. The pusher propeller aircraft of claim 11, wherein the one or more output openings comprise at least one nozzle having an adjustable angle.

14. The pusher propeller aircraft of claim 11, further comprising a control system configured to intermittently pulse the free air jet output by the blowing system in accordance with a speed of the propeller.

15. The pusher propeller aircraft of claim 11, wherein the blowing system further comprises at least one of a blower fan, an engine driven compressor, an electric compressor, and an engine bleed ducted to produce the free air jet blowing through the one or more output openings.

16. The pusher propeller aircraft of claim 1, further comprising a control system configured to set or adjust the free air jet’s mass flow based on one or more of the following: flight conditions, air speed, angle of attack, propeller rotation speed, and sensed acoustic properties.

17. A method of compensating for a low velocity air flow region generated by a wake of air flow formed during flight by a wing of a pusher propeller aircraft aftward of a trailing edge of the wing, the method comprising:
rotating a propeller of the pusher propeller aircraft, wherein the propeller is attached to the wing and is located aftward of the trailing edge of the wing; and
releasing at least one free air jet through one or more output openings at or proximate to the trailing edge of the wing, wherein the one or more output openings cooperatively span a width at least equal to a width of the propeller, wherein the at least one free air jet is directed toward and intersects blades of the propeller.

18. The method of claim 17, further comprising adjusting an angle of at least one nozzle fluidly coupled with the one or more output openings for improved filling in of the low velocity air flow region and enhanced mixing of the at least one free air jet with a free stream air flow outward of the low velocity air flow region.

19. The method of claim 17, intermittently pulsing the release of the at least one free air jet in accordance with a speed of the propeller.

20. The method of claim 17, further comprising setting or adjusting the at least one free air jet’s mass flow based on one or more of the following: flight conditions, air speed, angle of attack, propeller rotation speed, and sensed acoustic properties.
